(19) United States
(12) Patent Application Publication
(10) Pub. No.: US 2017/0102123 A1
(43) Pub. Date: Apr. 13, 2017

(54) Side-Mounted LED Light Emitting Method and Apparatus

(71) Applicant: Randall Dale Raischein, Tangent, OR (US)

(72) Inventor: Randall Dale Raischein, Tangent, OR (US)

(21) Appl. No.: 14/880,893

(22) Filed: Oct. 12, 2015

(51) Int. Cl. F21V 7/00; F21K 9/68; F21K 9/90; F21V 29/74

(52) U.S. Cl. CPC F21V 7/0083; F21V 29/74; F21V 7/005; F21K 9/68; F21K 9/90; F21Y 2115/10

(57) ABSTRACT

An apparatus containing light generating devices, such as LEDs, mounted in two opposing rows along the interior sides of an illumination area within the apparatus is provided herein. Light emitted from the devices are reflected out the front of the apparatus by a plurality of reflective pockets located in front of each device. The reflective pockets are aligned in two rows, each row of reflective pockets facing a row of light generating devices. The pockets are mounted at a generally 45-degree angle to the devices and to the front of the apparatus. The pockets cause the light emitted from each device to be reflected by approximately 90-degrees so that it exits the apparatus and illuminates an area roughly in front of the apparatus.

### BACKGROUND OF THE INVENTION

The present invention relates to LED illumination devices, and more specifically, to devices which employ a plurality of side-mounted light-emitting diodes.

### FIELD OF THE INVENTION

A light-emitting diode (LED) is a two-lead semiconductor light source. It is a P-N junction diode which emits light when activated by an electrical current. When a suitable voltage is applied to the leads, electrons are able to recombine with electron holes within the device, releasing light energy in the form of photons. This effect is called electroluminescence, and the color of the light, which corresponds to the energy of the photon, is determined by the energy band gap of the semiconductor. An LED is often small in area and integrated optical components such as, but not limited to, lenses, mirrors, or shaped reflectors may be used to shape outgoing radiation patterns.

Heat dissipation is known within the art. Of the incoming power to an LED, generally seventy-percent of that power is lost as heat radiation. As an LED acquires heat, permanent damage can occur to the diode, resulting in reduced service life, reduced efficiency, and unwanted color shifts.

In order to maintain a low junction temperature to keep good performance of an LED, every method of removing heat from LEDs should be considered. Conduction, convection, and radiation are the three means of heat transfer. Typically, LEDs are encapsulated in a transparent resin, which is a poor thermal conductor. Nearly all heat produced is conducted through the backside of the diode chip. Heat is generated from the P-N junction by electrical energy that was not converted to useful light, and conducted to outside ambience through a long path, from junction to solder point, solder point to board, and board to the heat sink and then to into the surrounding atmosphere.

Heat sinks are known within the art. Generally, a heat sink is a device that absorbs heat from one source and then dissipates that heat into a more-preferred area, such as the surrounding atmosphere. In order to transfer heat quickly and efficiently, heat sinks tend to be made of a material with a low heat capacity. Proximal to the heat source, this material will be dense and within contact of the source. Once the heat is transferred into the sink, the surface area of the sink increases greatly through a plurality of methods including, but not limited to, fins and the like. This allows for a larger transfer area with the surrounding atmosphere. Once heat is leached into the surroundings, the cooler material distal to the source will draw additional heat from the proximal sink, and subsequently, the source of heat.

Unfortunately, most LED devices require any heat sinks to be located on the side of the emitter, as electronic components such as, but not limited to, switches, power supplies, or additional circuitry are usually located directly behind the emitter. This can be problematic, as most of the heat is centrally located behind the emitter.

Light reflection is known within the art. Singular light-emitting diodes generally emit light energy in non-specific vectors. Without a lens or other directional device, LEDs will emit light patterns in all unobstructed directions. This can be troublesome for the user, as the light is diffused over a greater area, effectively reducing the amount of photons landing upon any preferred area. A lens or reflector is used to collect and focus these photons onto a more direct pathway, subsequently increasing the visible energy landing upon the area, and thus increasing brightness.

Locationally-based LED mounting is known within the art. Many current embodiments of light-emitting devices employ a cone-like, or otherwise depressionally-shaped reflecting unit surrounding an LED emitting photons out of the apparatus in an otherwise straight direction. Unfortunately, this sees the emitter located within the apparatus, trapping heat within the unit potentially causing damage to the emitter, circuit boards, or power supply.

Other manufacturers may prefer a non-direct emitting approach. This method employs an LED facing in a rearward direction onto the reflector. This allows for a better accuracy within the distribution of photons, as the emitter cannot freely pollute surroundings with its own light, and all photons coming from the apparatus are strictly controlled by the geometry of the reflector. Unfortunately, this also places the emitter directly in line with the energetic photons being reflected back onto the emitter. This increases the amount of heat being absorbed by the emitter, and disallows a substantial heat sink from being attached to the emitter board, as it would interfere with the reflected light from escaping the apparatus.

It could be said there lies a need for an LED device which can emit photons in a non-direct method, but allows a heat sink to be optimally located behind each emitter so as to improve cooling of the device.

The present invention meets this need by providing the user with a non-direct side-emitting LED emitter which is mounted to the side of the housing apparatus allowing for any heat to immediately be dissipated to the surrounding environment.

### BRIEF SUMMARY OF THE INVENTION

An embodiment of the present invention comprises an apparatus containing light generating devices, such as LEDs, mounted in two opposing rows along the interior sides of an illumination area within the apparatus. Light emitted from the LEDs are reflected out the front of the apparatus by a plurality of reflective pockets located in front of each LED. The reflective pockets are aligned in two rows, each row facing a row of LEDs. The pockets are mounted at a generally 45-degree angle to the LEDs and a generally 45-degree angle to the front of the apparatus. The pockets cause the light emitted from each LED to be reflected by approximately 90-degrees so that it exits the apparatus and illuminates an area roughly in front of the apparatus.

Other novel features which are characteristics of the invention, as to organization and method of operation, together with further and advantages thereof will be better understood from the following description considered in connection with the accompanying figures, in which preferred embodiments of the invention are illustrated by way of example. It is to be expressly understood, however, that the figures are for illustration and description only and are not intended as a definition of the limits of the invention. The various features of novelty which characterize the invention are pointed out with particularity in the following description. The invention resides not in any one of these features taken alone, but rather in the particular combination of all of its structures for the functions specified.

### BRIEF DESCRIPTION OF THE FIGURES

FIG. 1 is a perspective view of a side-mounted LED light emitting apparatus showing the left interior area of the apparatus as according to an embodiment of the present invention;

FIG. 2 is a perspective view of a side-mounted LED light emitting apparatus showing the right interior area of the apparatus as according to an embodiment of the present invention;

FIG. 3 is a front view of a side-mounted LED light emitting apparatus as according to an embodiment of the present invention;

FIG. 4 is a rear view of a side-mounted LED light emitting apparatus as according to an embodiment of the present invention;

FIG. 5 is a right side view of a side-mounted LED light emitting apparatus as according to an embodiment of the present invention;

FIG. 6 is a left side view of a side-mounted LED light emitting apparatus as according to an embodiment of the present invention;

FIG. 7 is a right end view of a side-mounted LED light emitting apparatus as according to an embodiment of the present invention;

FIG. 8 is a left end view of a side-mounted LED light emitting apparatus as according to an embodiment of the present invention;

FIG. 9 is partial front view of a side-mounted LED light emitting apparatus showing the side-mounted LED emitters in the left interior area of the apparatus as according to an embodiment of the present invention;

FIG. 10 is partial front view of a side-mounted LED light emitting apparatus showing the side-mounted LED emitters in the right interior area of the apparatus as according to an embodiment of the present invention;

FIG. 11 is a detail front view of a side-mounted LED light emitting apparatus showing the side-mounted LED emitters in the left interior area of the apparatus as according to an embodiment of the present invention; and

FIG. 12 is a detail front view of a side-mounted LED light emitting apparatus showing the side-mounted LED emitters in the right interior area of the apparatus as according to an embodiment of the present invention.

A further understanding of the present invention can be obtained by reference to a preferred embodiment set forth in the accompanying description. Although the illustrated embodiments are merely exemplary of methods for carrying out the present invention, both the organization and method of operation of the invention, in general, together with further objectives and advantages thereof, may be more easily understood by reference to the illustrations and the following description. The figures are not intended to limit the scope of this invention, but merely to clarify and exemplify the invention.

### DETAILED DESCRIPTION OF THE INVENTION

In the following detailed description, reference is made to specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method(s) or apparatus include the discussed feature, advantage or mode of operation. The following description of the preferred embodiment is merely exemplary in nature and is in no way intended to limit the invention, its application, or use.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter. Those skilled in the art will appreciate that the conception upon which this disclosure is based may be readily utilized as a basis for the designing of other structures, methods and systems for carrying out the purposes of the present invention. It is important, therefore, that any embodiments of the present invention be regarded as including such equivalent constructions insofar as they do not depart from the spirit and scope of the present invention.

Further, the purpose of the Abstract herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application nor is it intended to be limiting as to the scope of the invention in any way.

Referring now to the present invention, there is introduced a side-mounted LED light emitting apparatus comprised of a plurality of LEDs mounted at an approximately 45-degree angle to a plurality of reflecting areas within the apparatus. For the purpose of clarity, all like elements mentioned in this description will have the same designations. The terms “side-mounted LED light emitting apparatus”, “LED apparatus”, “apparatus”, “invention”, and “present invention” may be used interchangeably. In addition to the functions, features, components, and abilities of the invention already discussed in this specification, the invention may also have, but not be limited to, the following features contained within the description below.

The present invention solves the shortcomings of the prior art by providing a side-mounted LED light emitting apparatus that allows a plurality of side-mounted LEDs to illuminate an area at an approximately tangential angle to the plane of the LEDs. The preferred embodiments described below set forth the present invention in greater detail.

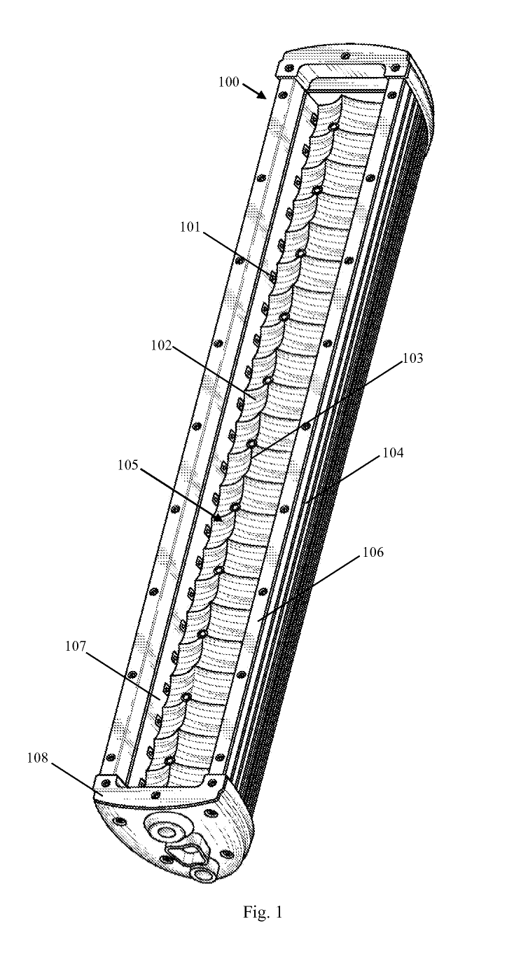

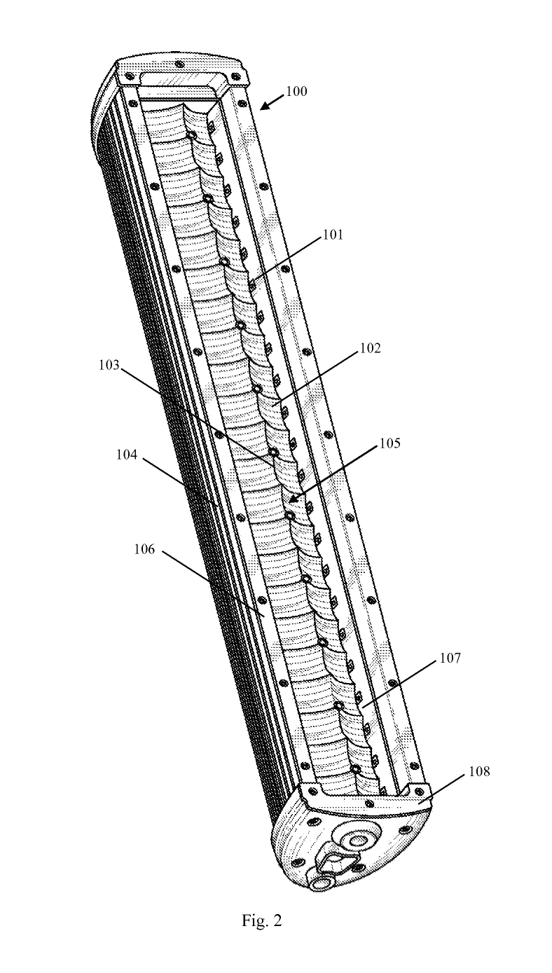

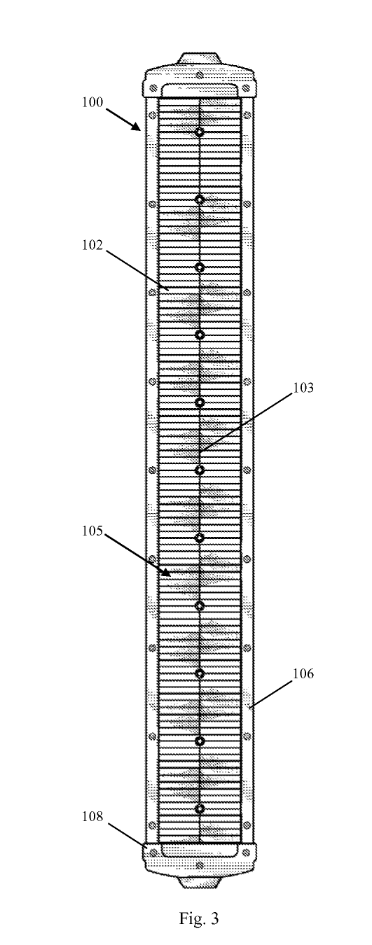

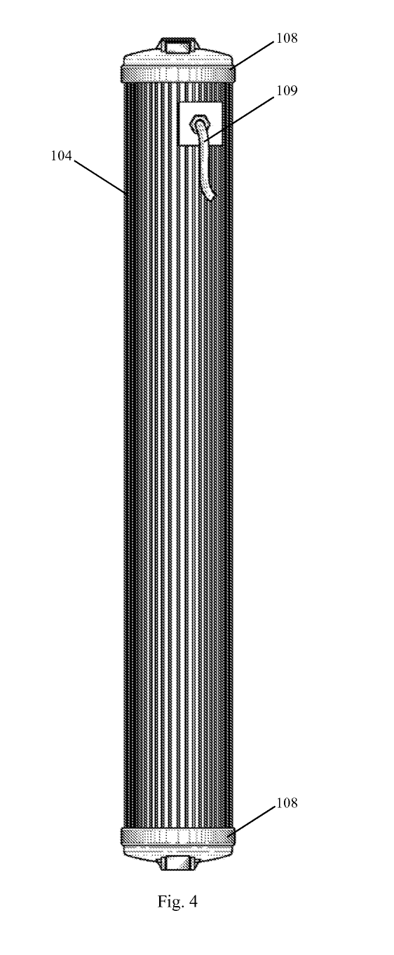

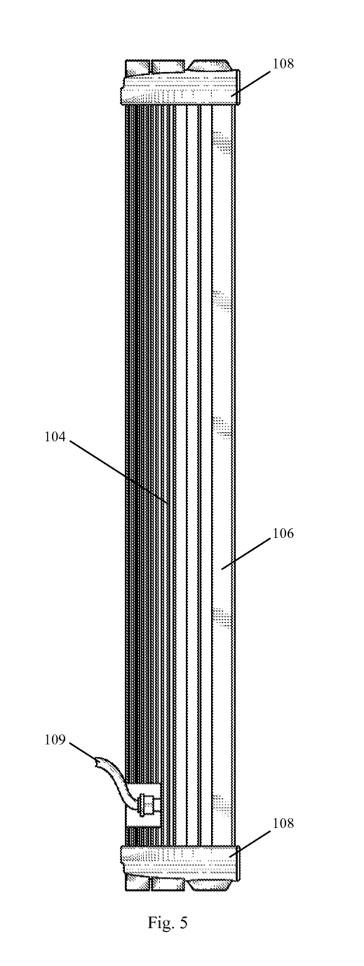

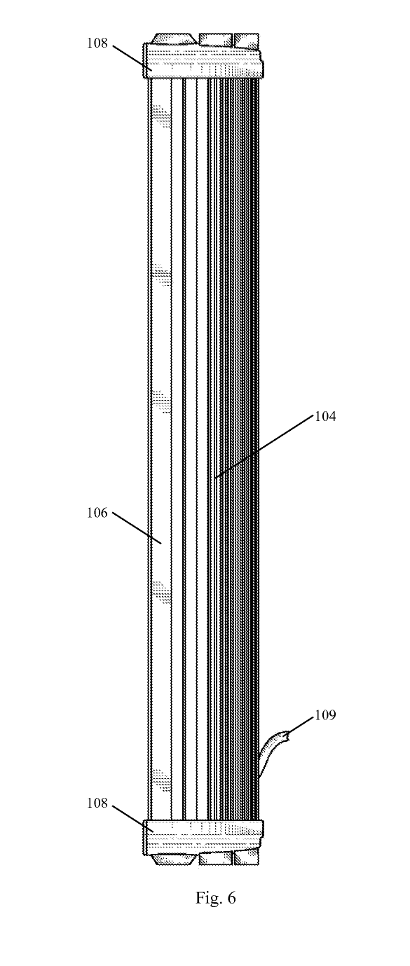

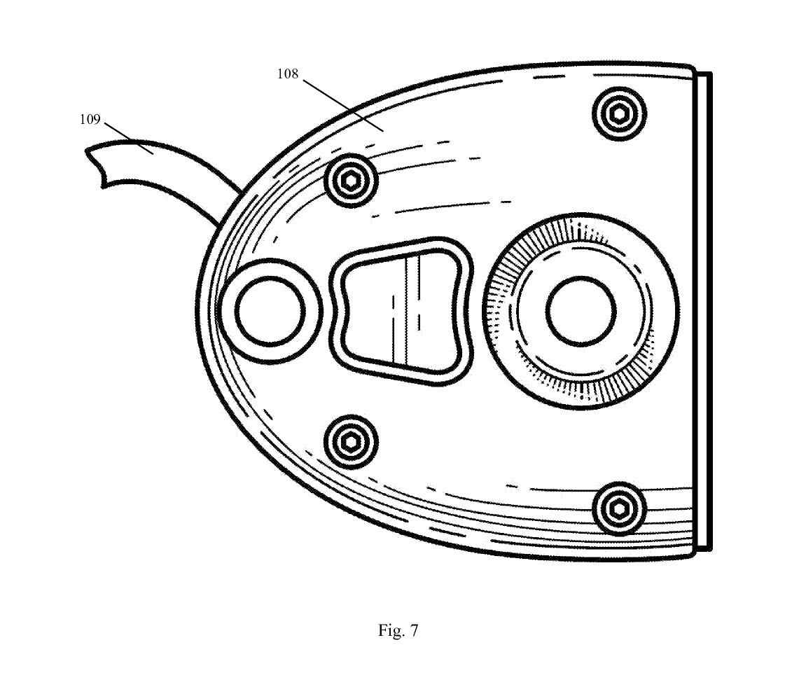

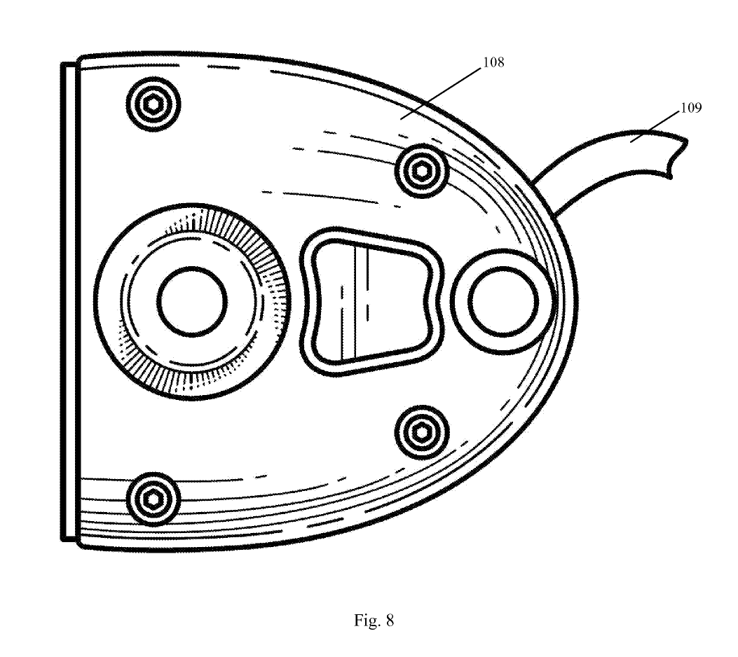

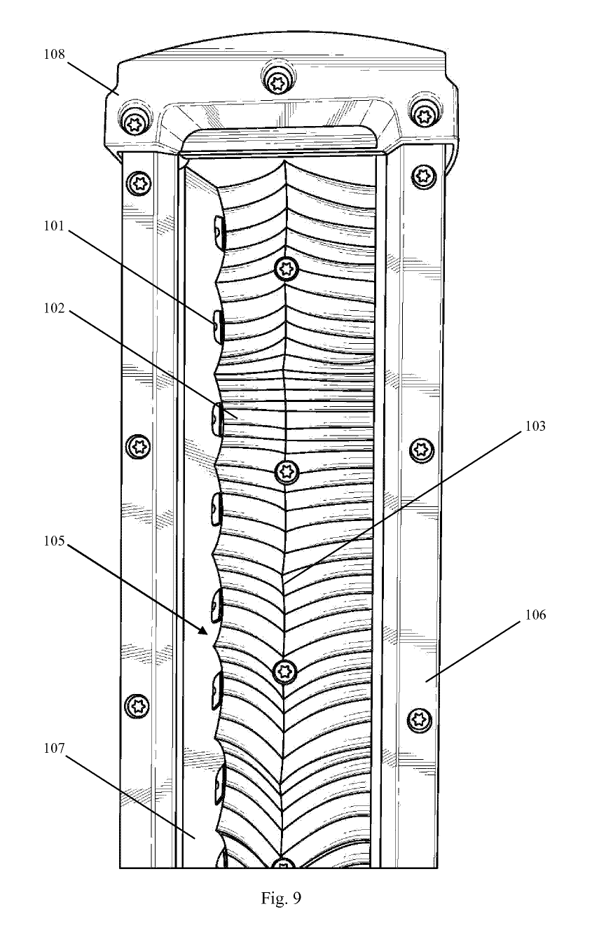

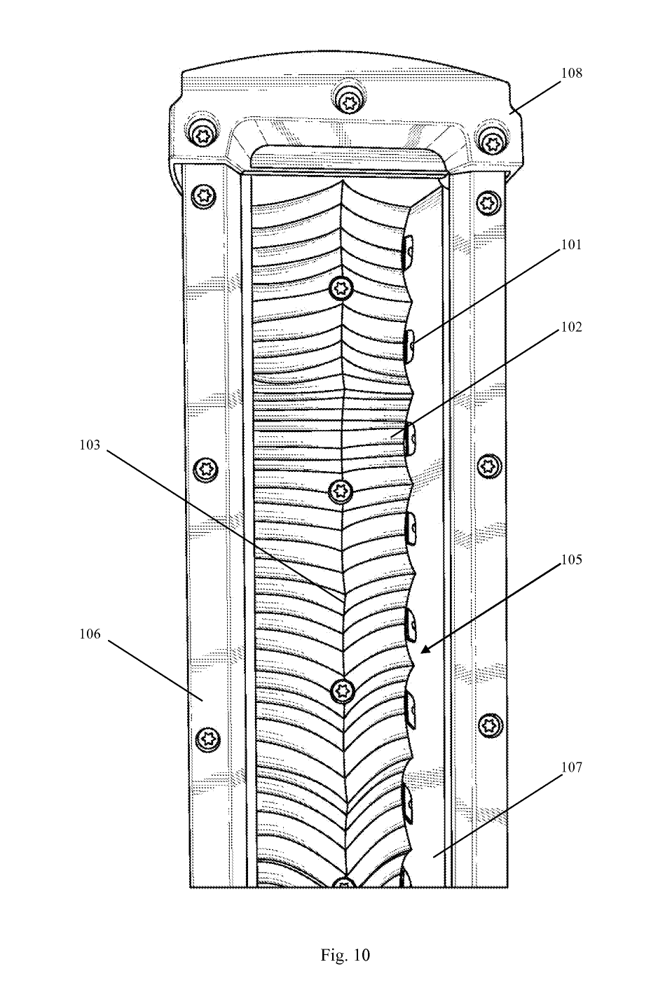

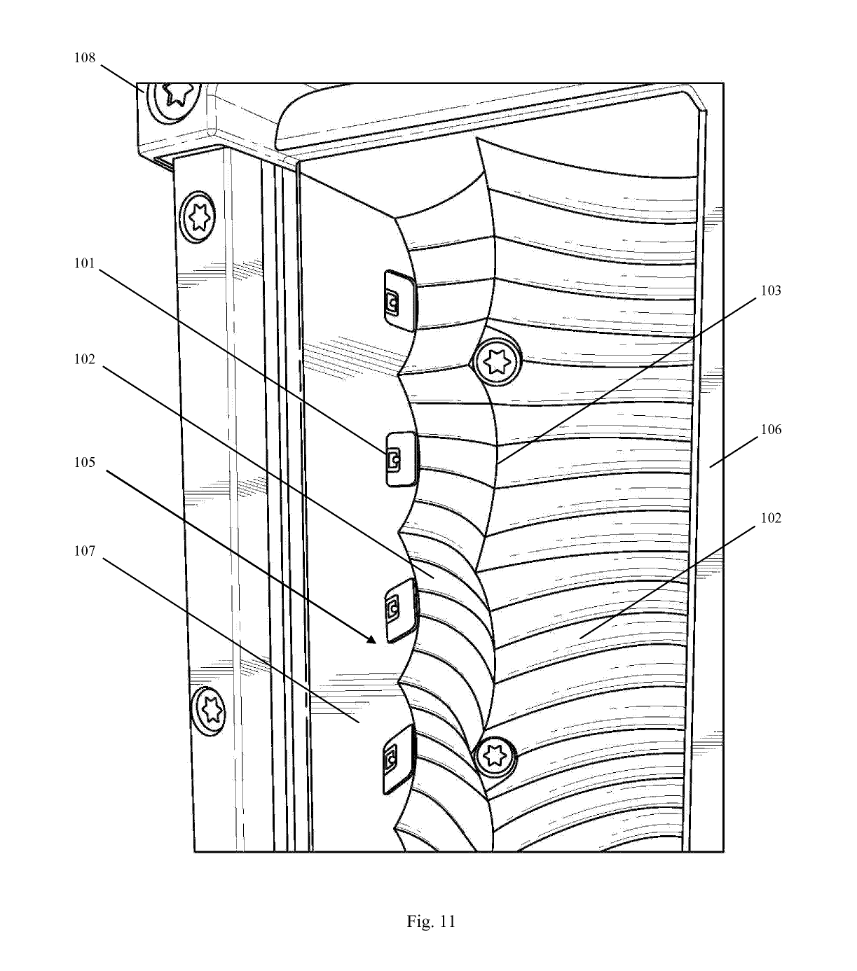

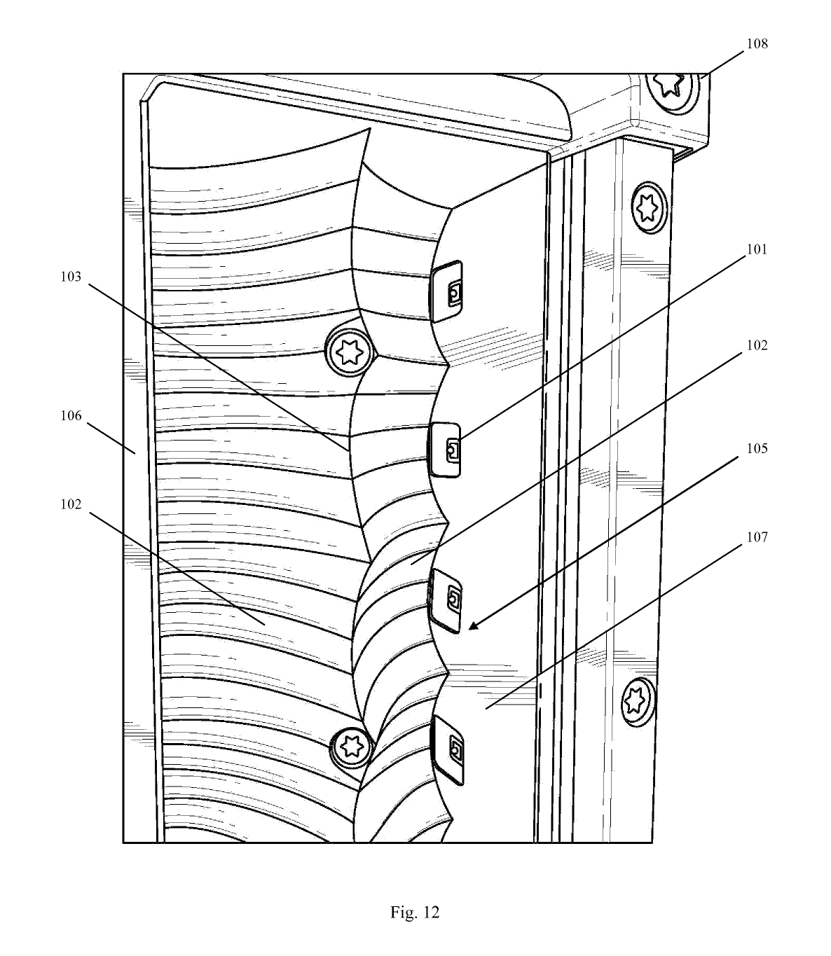

Referring now to FIGS. 1-12 that will be discussed together, there are shown views of a side-mounted LED light emitting apparatus (100) as according to an embodiment of the present invention. The apparatus (100) generally comprises a plurality of light generating devices (101), such as LEDs, that are mounted along a side (107) of the interior of an illumination area (105) of the apparatus (100). The light generating devices (101) emit light into a reflective area (102) within the illumination area (105) that is immediately in front of each light generating device (101). The purpose of the reflective area (102) is to cause dispersion of the emitted light at an approximately 90-degree angle to which the light was initially travelling. That is, the reflective area (102) reflects light emitted from each light generating device (101) out of the front of the apparatus (100) so that an area that is located roughly in front of the apparatus (100) is illuminated.

Mounting the light generating devices (101) along the side (107) of the illumination area (105) of the apparatus (100) allows the light generating devices (101) and any heat sinks necessary for cooling the light generating devices (101) to be optimally located to minimize the overall size of the apparatus (100). The heat sinks required for cooling the electronics within the apparatus (100) can be placed closer to the exterior of the apparatus (100) and can transfer heat to cooling fins (104) that are located on the exterior of the apparatus (100) in a more efficient manner. The cooling fins (104) transfer heat generated by the electrical components of the apparatus (100) to the air surrounding the apparatus (100). The fins (104) are constructed of a material with a high thermal conductivity to allow for increased heat being conducted from the apparatus (100) through the fins (104).

The reflective area (102) that reflects light emitted from each light generating device (101) at a nearly 90-degree angle from the direction that the light was initially emitted can be segmented, as shown in the accompanying figures, or can be rounded. The segmentation or rounding of the reflective areas (102) serves to capture emitted light from the light generating devices (101) and reflect the light in a focused manner tangentially out of the front of the apparatus (100). The apparatus (100) is expected to be positioned so that light emitted from the light generating devices (101) will illuminate an area at a distance in front of the apparatus (100). The distance from the apparatus (100) at which an area will be illuminated is variable. The distance can be as short as immediately in front of the apparatus (100) to as far away as light emitted from the light generating devices (101) will travel.

In some embodiments of the present invention, the reflective area (102) is comprised of a plurality of concave pockets; with one concave pocket in front of each light generating device (101). The concavity of the pocket further serves to capture and focus light in an efficient manner so that the light effectively illuminates an area in front of the apparatus (100).

light generating devices (101) are mounted along both sides (107) of the apparatus (100). Some embodiments of the present invention provide an illumination area (105) within the apparatus (100) where a row of light generating devices (101) is mounted along a side (107) of the apparatus (100) and a second row of light generating devices (101) is mounted on an opposite side (107) of the apparatus (100) so that each row of light generating devices (101) faces each other. In this embodiment of the present invention, the light generating devices (101) are opposed to each other at a nearly 180-degree orientation. That is, one row of light generating devices (101) faces a second row of light generating devices (101) in the illumination area (105) of the apparatus (100).

In some embodiments of the present invention, the reflective area (102) is located between two opposing rows of light generating devices (101). The reflective area (102) is positioned and shaped so that light from each opposing row of light generating devices (101) is translated at an approximately 90-degree angle from which it was originally emitted by each light generating device (101). The light from each row of light generating devices (101) is initially emitted directly toward the other row of light generating devices (101), but reflected in a similar direction out the front of the apparatus (100) by the reflective area (102).

In some embodiments of the present invention, the reflective area (102) is comprised of at least two rows of reflective, concave pockets. In an embodiment of the present invention, each pocket can be comprised of segmented reflective strips that directs the light emitted from each light generating device (101) out of the front of the apparatus (100). Where the rows of concave pockets meet form a centerline (103) within the lighting area (105). Each reflective strip is shaped and oriented so that light striking the strip is reflected from its direction of travel as emitted from the light generating device (101) to a direction that allows the light to travel out of the front of the apparatus (100). In another embodiment of the present invention, each pocket can be comprised of a curved reflective surface that directs the light emitted from each light generating device (101) out of the front of the apparatus (100).

In an embodiment of the present invention, the rows of reflective pockets in the reflective area (102) are oriented at a general angle of 45 degrees to the light generating devices (101) and to the plane of the front of the apparatus (100). The effect of the angular orientation of the rows of reflective pockets is to reflect the light emitted from the light generating devices (101) at a general angle of ninety degrees from its direction of emittance.

In an embodiment of the present invention, the sides (107) of the interior illumination area (105) that house the light generating devices (101) comprises part of a wall (106) of the apparatus (100). The wall (106) further comprises attachment areas along the top of the wall (106) for attaching a transparent, protective cover in some embodiments of the present invention. Some embodiments of the present invention can use a glass transparent cover while other embodiments include a plastic or, hybrid glass or plastic cover, to protect the illumination area (105).

The walls (106) of the apparatus (100) further comprise areas for attaching the cooling fins (104) to the exterior of the apparatus (100). To facilitate enhanced heat transfer, in some embodiments of the present invention the walls (106) are constructed of a material with a high thermal conductivity. The walls (106) are also of sufficient width to allow the light generating devices (101) and other electrical components to be housed within them. Some of the electrical components that can be housed within the walls (106) include the heat sinks or electrical connections for each light generating device (101).

End caps (108) are connected to the walls (106) of the apparatus (100). The end caps form the ends of the apparatus (100) further enclosing the illumination area (105) and protecting the area (105) from damage or contamination. The end caps (108) can have attachment areas for mounting the apparatus (100) to vehicles, buildings, or the like. The attachment areas on the end caps (108) can be molded as part of the end caps (108), as illustrated in the accompanying figures, or can be separate components that are fastened to the end caps (108).

Electricity is provided to the apparatus (100) by way of an electrical cord (109). The cord (109) is connected at one end to a power source, and at the other end to electrical components within the apparatus (100). The cord (109) can enter the apparatus (100) at various locations, including through the back of the apparatus (100) as illustrated in the accompanying figures.

In another embodiment of the present invention, a method for providing a side-mounted LED light emitting apparatus (100) is described. In this embodiment of the present invention, light generating devices (101) are provided and attached within the interior sides (107) of an illumination area (105) within the apparatus (100). At least two reflection areas (102) are provided that reflect light emitted from the light generating devices (101) at an approximately 90-degree angle out of the front of the apparatus (100). The light illuminates an area generally in front of the apparatus (100). Cooling fins (104) are attached to the walls (106) of the apparatus (100) so that heat generated by the electrical components of the apparatus (100) is effectively dissipated. End caps (108) are provided that further enclose the illumination are (105), light generating devices (101), reflective area (102), and interior sides (107) of the apparatus (100). In some embodiments of the present invention, a transparent cover is attached to the walls (106) and end caps (108) so that the illumination area (105), light generating devices (101), reflective area (102) and interior sides (107) are protected from damage or contamination by foreign debris. A power cord (109) is attached to the apparatus (100) so that electricity is provided to the electrical components of the apparatus (100).

It should be noted that some embodiments of the present invention provide a waterproof housing. These embodiments allow the apparatus (100) to operate in damp conditions, or when completely submerged.

It should be further noted that the shape of the apparatus (100) is designed so that wind passing over the apparatus (100) enhances the cooling efficiency of the cooling fins (104).

There are described and illustrated new and improved side-mounted LED light emitting apparatus, and methods for formulating the side-mounted LED light emitting apparatus. The inventive portions of the side-mounted LED light emitting apparatus include several components and steps that, when taken together, constitute an embodiment of the present invention. The above detailed description sets forth rather broadly the more important features of the present invention in order that its contributions to the art may be better appreciated.

As such, those skilled in the art will appreciate that the conception, upon which disclosure is based, may readily be utilized as a basis for designing other structures, methods, and systems for carrying out the several purposes of the present invention. It is important, therefore, that this description be regarded as including such equivalent constructions insofar as they do not depart from the spirit and scope of the present invention.

Although certain example methods, apparatus, apparatus and articles of manufacture have been described herein, the scope of coverage of this application is not limited thereto. On the contrary, this application covers all methods, apparatus and articles of manufacture fairly falling within the scope of the invention either literally or under the doctrine of equivalents.

Directional terms such as “front”, “forward”, “back”, “rear”, “in”, “out”, “downward”, “upper”, “lower”, “top”, “bottom”, “upper”, “lower” and the like may have been used in the description. These terms are applicable to the embodiments shown and described herein. These terms are merely used for the purpose of description and do not necessarily apply to the position in which components or items within the present invention may be used.

Therefore, the foregoing is considered as illustrative only of the principles of a side-mounted LED light emitting apparatus. Further, since numerous modifications and changes will readily occur to those skilled in the art, it is not desired to limit the side-mounted LED light emitting apparatus to the exact construction and operation described, and accordingly, all suitable modifications and equivalents may be resorted to, falling within the scope of the present invention. While the above description describes various embodiments of the present invention, it will be clear that the present invention may be otherwise easily adapted to fit other configurations.

As various changes could be made in the above constructions without departing from the scope of the invention, it is intended that all matter contained in the above description shall be interpreted as illustrative and not in a limiting sense.

I claim:

1. A light-emitting apparatus comprising:
a first row of light generating devices;
a second row of light generating devices;
a reflective area;
wherein the first row of light generating devices is housed within a first side of the apparatus;
wherein the second row of light generating devices is housed within a second side of the apparatus;
the first and second row of light generating devices facing each other; and
wherein the reflective area is located between the first and second row of light generating devices so that the light emitted by each device is reflected by the reflective area at a generally 90-degree angle out of the apparatus.

2. The apparatus of claim 1, further comprising cooling fins located on the exterior of the apparatus.

3. The apparatus of claim 1, further comprising a power cord that provides electricity to the electrical components of the apparatus.

4. The apparatus of claim 1, further comprising at least one wall that houses a row of light generating devices.

5. The apparatus of claim 4, further comprising an end cap that attaches to the wall.

6. The apparatus of claim 4, wherein the wall further comprises attachment areas for attaching a protective transparent cover to the apparatus.

7. The apparatus of claim 1, further comprising an illumination area where the first row of light generating devices, second row of light generating devices and reflective area are located.

8. An apparatus for illuminating an area comprising:
a first row of LEDs;
a second row of LEDs;
a first row of reflective pockets;
a second row of reflective pockets;
wherein the first row of LEDs is mounted inside of the apparatus so that it faces the second row of LEDs;
wherein the first row of reflective pockets reflects the light emitted from the first row of LEDs at an approximately 90-degree angle out of the apparatus;
wherein the second row of reflective pockets reflects the light emitted from the second row of LEDs at an approximately 90-degree angle out of the apparatus;
and wherein the first and second row of reflective pockets are located between the first and second row of LEDs.

9. The apparatus of claim 1, wherein each reflective pocket reflects the light emitted from a single LED.

10. The apparatus of claim 1, wherein each reflective pocket of the first and second row of reflective pockets are constructed of segmented reflective strips.

11. The apparatus of claim 1, wherein the first row and second row of reflective pockets are oriented at an approximately 45-degree angle from the first and second row of LEDs, respectively.

12. The apparatus of claim 1, further comprising cooling fins that are mounted to a first and second exterior wall of the apparatus.

13. The apparatus of claim 12, wherein a first and second end cap are connected to each end of the first and second exterior wall.

14. The apparatus of claim 13, wherein a protective transparent cover is attached to the first and second exterior wall and to the first and second end cap.

15. A method for providing a side-mounted LED light emitting apparatus comprising the steps of:
providing a first row of light generating devices;
providing a second row of light generating devices;
orienting the first row of light generating devices so that it faces the second row of light generating devices;
orienting the second row of light generating devices so that it faces the first row of light generating devices;
providing a first row of reflective pockets in front of the first row of light generating devices and orienting the first row of reflective pockets so that the reflective pockets will reflect light emitted from the first row of light generating devices at an approximately 90-degree angle out of the apparatus; and
providing a second row of reflective pockets in front of the second row of light generating devices and orienting the second row of reflective pockets so that the reflective pockets will reflect light emitted from the second row of light generating devices at an approximately 90-degree angle out of the apparatus.

16. The method of claim 15, further comprising providing LEDs as the light generating devices.

17. The method of claim 15, further comprising locating the first row of light generating devices within a first side of the apparatus and locating the second row of light generating devices within a second side of the apparatus.

18. The method of claim 17, further comprising constructing the first and second side of the apparatus so that each side is reflective.

19. The method of claim 15, further comprising constructing each pocket of the first and second row of reflective pockets from segmented reflective strips.

20. The method of claim 15, further comprising constructing each pocket of the first and second row of reflective pockets from a curved reflective surface.
